(19) United States
(12) Patent Application Publication
(10) Pub. No.: US 2024/0267964 A1
(43) Pub. Date: Aug. 8, 2024

(54) METHOD FOR RELAY SELECTION BASED ON COMPOSITE MULTI-INTERFACE LOAD METRIC

(71) Applicant: Continental Automotive Technologies GmbH, Hannover (DE)

(72) Inventors: Andreas Andrae, Frankfurt am Main (DE); David Gonzalez Gonzalez, Egelsbach (DE); Osvaldo Gonsa, Frankfurt (DE)

(73) Assignee: Continental Automotive Technologies GmbH, Hannover (DE)

(21) Appl. No.: 18/290,170

(22) PCT Filed: May 6, 2022
(86) PCT No.: PCT/EP2022/062246

§ 371 Date: Nov. 10, 2023

(30) Foreign Application Priority Data
May 11, 2021 (DE) 10 2021 204 774.2

(51) Int. Cl. H04W 76/14; H04W 88/04

(52) U.S. Cl. CPC H04W 76/14; H04W 88/04

(57) ABSTRACT

Method for Relay Selection based on Multi-Interface Load Metric between communication subscribers, which can each communicate with at least one base station via at least one communication interface for communication, in which the following steps are carried out on the part of the base station for establishing communication, determining local and thematic information for determining communication subscribers, determining a group of communication subscribers based on the local and thematic information, wherein a local area is defined for local restriction of the communication subscribers and wherein at least one of a technological aspect and an interest-related aspect is used for thematic restriction on the part of the base station is characterized by granting permission to communicate data from a group of communication subscribers to the at least one base station is established via further communication subscribers by using discovery mechanisms between them.

### TECHNICAL FIELD

The present invention relates to a wireless communication network comprising base stations and wireless relay stations, and more specifically, to a method for updating the connection relationship of a wireless relay station in the wireless communication network.

### BACKGROUND

This disclosure pertains to mobile communications. See, for example, 3GPP TR 22.886, Study on enhancement of 3GPP Support for 5G V2X Services; (Release 15), V15.1.0; 3GPP TS 22.186, Enhancement of 3 GPP support for V2X scenarios; Stage 1 (Release 15), V15.2.0; 3GPP TS 36.321, E-UTRA Medium Access Control (MAC) protocol specification (Release 15), V15.1.0; 3GPP TS 36.300, Overall description; Stage 2 (Release 15), V15.1.0; 3GPP TS 24.386: User Equipment (UE) to V2X control function; protocol aspects; Stage 3 (Release 14), V14.3.0; 3GPP TS 38.321, NR Medium Access Control (MAC) protocol specification (Release 15), V15.0.0; 3GPP R2-1809292, Introduction of V2X duplication to TS 36.323, CATT; 3GPP TS 36.331, Radio Resource Control (RRC); Protocol specification (Release 15), V15.1.0.; 3GPP TR 38.885, NR; Study on Vehicle-to-Everything, V 1.0.0; and 3GPP TR 38.836 V17.0.0 (2021-03), TSG RAN WG2 specifies the results of its “Study on NR sidelink relay” for 3GPP's (Release 17).

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipment (UE). A base station may communicate with UEs on downlink channels e.g., for transmissions from a base station to a UE and uplink channels e.g., for transmissions from a UE to a base station. UEs may be assigned an access class parameter associated with barring protocols that control access to the base station in certain emergency scenarios, for example. Normal (or non-high priority) UEs may be assigned an access class 0-9. High priority UEs may be assigned an access class 11-15. Other access classes may be assigned based on a service e.g., audio/video telephone services, messaging services, etc. When access class barring is active, the barring condition and assigned access class parameter may determine whether resources are available for a particular UE or service.

Device-to-device (D2D) communications involve direct wireless communications between UEs. D2D communications may provide for proximity service functions to be performed between UEs within the same geographic area. Example proximity service functions may include announcements within a defined geographic area, sale information within a shopping mall, etc. UEs may communicate via D2D proximity service communications by accessing resources associated with direct discovery, direct communications, etc. Current access class barring procedures may not consider D2D proximity service communications and, therefore, UEs may experience difficulty, or be prevented from, accessing resources for D2D proximity service communications when access class barring is active.

US 2013250918 A1 discloses a method for performing radio usage measurements to support radio link operations and/or load balancing may be performed at an evolved Node B (eNB). The method determining a first radio usage parameter. The first radio usage parameter is measurement of radio usage between an eNB and at least one wireless transmit receive unit (WTRU). The method includes determining a second radio usage parameter. The second radio usage parameter is a measurement of radio usage between the eNB and at least one relay node (RN) served by the eNB. The method includes utilizing at least one of the first radio usage parameter or the second radio usage parameter to evaluate at least one of evolved universal terrestrial radio access (E-UTRA) radio link operations, radio resource management (RRM), network operations and maintenance (OAM), and self-organizing networks (SON) functions or functionalities.

US 2011110270 A1 describes a solution of reconstructing the network topology according to the traffic related information of each cell, so as to achieve self-optimization of network. The traffic related information of a cell includes the traffic related information applicable to network topology reconstruction, or load related information as is named, including to time-frequency resource related amount that is used by the traffic data in the cell, traffic throughout of each cell or the wireless channel quality of each cell for transmitting traffic data, etc. The solutions realize the network topology reconstruction according to traffic related information of multiple cells, therefore the network capacity and service quality could be improved and the wireless relay communication network is applicable to those areas with unpredictable traffic distribution.

US 2010054155 A1 depicts a method for updating a connection relationship of a wireless relay station, comprises the following steps of: (a) a wireless relay station RS1 already connecting to a wireless communication network group comprising a base station and wireless relay stations subjected to the base station, and if determining that the connection relationship of RS1 needs to be changed, selecting a target node; (b) instructing RS1 to update the connection to the target node, and after receiving the instructions, RS1 starting a connection update, establishing a wireless link to a new node and releasing no longer used resource in an existing data tunnel.

US 2011228719 A1 describes a wireless communication system. The wireless communication system comprises a core network, a base station and a relay station. The relay station transmits a first message with a system resource information of the relay station to the base station. The base station generates a configuration pattern according to the system resource information of the relay station and transmits a second message with the configuration pattern to the relay station. The configuration pattern is used to divide the radio resource unit of the wireless communication system into a first set and a second set. Therefore, the base station transmits a first signal to the relay station through the first set, and the relay station transfers a second signal with a user equipment through the second set.

US 2018084481 A1 discloses a method for determining a D2D relay node, including steps of: measuring, by a first UE, its own running state; in the case that the first UE determines that its own running state meets a predetermined condition in accordance with a measurement result, determining the first UE as a relay node; and notifying, by the first UE, other UEs currently using a D2D link that the first UE is the relay node via a PC5 interface.

US2010285743 A1 provides a disclosure for a mobile communication data transmission method for a cell having one base station and more than one relay station involves switching the relay stations between at least two operating modes of signaling transmission under the control of the base station. A system transmits mobile communication data in a cell having one base station and more than one relay station. When transmitting an uplink signaling or a downlink signaling, the relay stations switch between at least two operating modes under the control of the base station. By using the method, network, relay station, and base station, data transmission in multiple modes can be achieved, so as to achieve a flexible relay scheme.

EP 3794887 A1 enhances a sidelink communication operations through the use of communications requirement signaling, which may include, for example, indications of the type, size, quality of service requirements, pending buffer sizes, and the like, and through the evaluation of such signaled information to determine whether existing grants and logical channels may suffice for new sidelink traffic. Grants may be requested via sidelink scheduling requests and sidelink buffer status reporting, for example, which allow scheduling devices, such as base stations and scheduling user equipment apparatuses, early insight into needs of sidelink traffic for application with divergent QoS requirements.

CN 101389113 A provides a method for distributing radio resource to relays, comprising that after finishing base station access of the relay, the base station distributes radio resource for the relay to communicate with terminals to the relay; the relay transmits radio resource request and channel condition between base stations to the base station thereafter; according to the channel condition and received radio resource request, the base station reserves a part of the radio resource to the relay for communication between the base station and the relay.

CN 102404759 A discloses a load bearing multiplexing method and a system of a Un interface, which are used for achieving the effect that EPS bearer of the same UE is multiplexed on EPS bearer of the same RN. The technical scheme is that a relay node/donor base station manages multiplexing relation between the EPS bearer of the UE and the EPS bearer of the RN, wherein the relay node (or the donor base station) transmits S1 signaling carrying the multiplexing relation or radio resource control (RRC) signaling to the donor base station (or the relay node). The multiplexing relation is indicated commonly through the EPS bearer identification of the UE and the EPS bearer identification of the RN. The load bearing multiplexing method and the system of the Un interface can achieve the effect that the EPS bearer of the same UE is multiplexed on the EPS bearer of the same RN, and the multiplexing mode is flexible.

US 2017339597 A1 describes an information processing device including: a processor configured to: determine a priority degree of each of a plurality of communication terminals based on service information indicative of a service utilizable by each of the plurality of the communication terminals, the more number of service utilizable by a communication terminal the higher priority degree of the communication terminal, for each communication terminal selected in descending order of the priority degree, identify at least one of a plurality of relay apparatuses capable of being utilized by the communication terminal based on the service information, select a relay apparatus to provide the service to the communication terminal from the at least one of the plurality of relay apparatus based on load information indicative of load applied to each relay apparatus.

CN 101494899 A describes an inter-cell interference coordination method in radio communication network with relay station, including the interference coordination to base station covering area and relay station covering area. The method comprises: firstly, selecting limited interference source; then, dividing the cell including the limited interference source into several layers, and setting resources reservation distribution mode, service quality priority number and link loss compensation factor; finally, determining to start the random accessing process or the power adjusting process according to interference signal intensity. When the time frequency resource in the limited interference source distributed area is in heavy load or full load, and the flexible scheduling and separating of the time frequency resource is different from that of the time frequency resource of the limited interference source, The limited interference source selection, area dividing and time frequency resource distribution mode in the invention are beneficial to ensure the time frequency resource orthogonal, reduce inter-cell interference, and guarantees service quality while meets the minimum service quality.

U.S. Ser. No. 10/123,346 B1 describes how backhaul data may be communicated between an access node and a relay wireless device, wherein the relay wireless device serves as backhaul for a plurality of end-user wireless devices and a set of the plurality of the end-user wireless devices comprise a quality of service metric that meets a quality of service criteria. Wireless resources may be scheduled for the relay wireless device using semi-persistent scheduling such that wireless resources are pre-allocated for the relay wireless device based on a periodicity. And data may be transmitted according to the semi-persistent scheduling from the access node to the relay wireless device based on the periodicity, wherein data for the set of end-user wireless devices that is received at the access node between transmissions for the semi-persistent scheduling is queued such that it is transmitted to the relay wireless device at a next transmission for the semi-persistent scheduling.

WO 2021007852 A1 is related to a method performed by user equipment (UE). The method includes: determining whether a uplink (UL) transmission and a sidelink (SL) transmission overlap in time domain; and in response to the UL transmission and the SL transmission overlapping in time domain, determining, based on quality of service (QoS) requirements of the UL transmission and the SL transmission, transmitting which one of the UL transmission and the SL transmission and not transmitting the other one of the UL transmission and the SL transmission.

From an end-to-end perspective, it is suboptimal and questionable whether the minimum QoS requirements of a remote UE being an end user or vehicle operating out of mobile network coverage could be met, if a load metric based on only one interface is considered, i.e., if only PC5 is considered for assessing the relay UE's load.

Today, only simple metrics are considered for assessing the relay node's load such as number of PC5 connections to Remote UEs currently being actively used for relaying, resource pool usage or capacity, data rate at the different layers of the relay UE(s) for relaying data, buffering capacity available or buffer load for relayed data on the Relay UE, average time the relayed data stays within the Relay UE, number of remote UEs being served by the relay UE, load level, e.g. high/low, configured by gNB.

The proposed invention addresses the problem of relay selection single-hop or multi-hop PC5-to-Uu relaying by introducing a composite load metric. The motivation for this approach is generated by the fact that, considering only the PC5 interface load may result in connecting to a Relay UE that is not able to meet the Remote UE's E2E QoS requirements, and triggering a Relay UE (re-)selection procedure that most likely will not be successful and that consumes time and energy. Thus, connecting to a “wrong” Relay UE is not efficient, since an immediate relay (re)selection is likely/needed, introducing unnecessary interference, delay in network access, increased energy consumption, as well as deteriorated QoS.

In addition, for this type of wireless communication network, there is no reasonable solution provided in the prior art to solve the cited problem above problems such as how a wireless relay station to join a wireless communication network group, how to update a connection relationship, and how to terminate a connection relationship in order to reduce unnecessary interference, delay in network access, energy consumption, as well as to increase QoS.

A particular advantage results in a solution for providing connectivity to vehicles/devices located outside of mobile network coverage by using relay nodes. Furthermore, enhanced relay node selection mechanism can account for user's Quality of Service requirements. The proposed invention can also be used in other important tasks associated to the operation of relays, such as load balancing and resource allocation optimization. Extensions towards multi-hop relaying are also possible.

### BRIEF SUMMARY

Regarding QoS management, the following summarizes the corresponding invention: The gNB implementation can handle the QoS breakdown over Uu and PC5 for end-to-end QoS enforcement, and this breakdown can be flexibly tailored to the AS conditions on sidelink and Uu. Details of handling in case PC5 RLC channels with different E2E QoS are mapped to the same Uu RLC channel are discussed in the normative phase. Therefore, the end-to-end QoS enforcement can be supported. In case of OOC, Remote UE operates using the configuration provided in SIB or dedicated RRC signaling with overall better QoS performance than using pre-configuration. QoS can be enforced for each bearer as the gNB can decide whether an E2E bearer is admitted or not depending on the current congestion.”

For L2 UE-to-Network relay, the Relay UE may provide UAC parameters to Remote UE for performing Remote UE access control and RAN overload control. The access control check is performed at Remote UE using the parameters of the cell it intends to access. Remote UE access control can take SL congestion into account as the gNB is aware of the congestion status between Remote UE and Relay UE, using legacy CBR measurements.”

### BRIEF DESCRIPTION OF THE DRAWINGS

FIG. 1a shows the scenario 1, which displays that remote UE is OOC and UE-to-NW relay is IC.

FIG. 1b shows the scenario 1, which displays that remote UE is IC and UE-to-NW relay is IC.

FIG. 1c shows the scenario 1, which displays that remote UE is in different cell coverage than UE-to-NW relay.

FIG. 2 shows that the PC5 interface constitutes the first communication “hop” between Remote UE and Relay UE.

FIG. 3 illustrates load relay UE #1 and load Relay UE #2 are connected to BS #1 and BS #2, and they are both operating as Relay UE towards their respective BS.

### DETAILED DESCRIPTION

The present invention will be described in detail with combination of the accompanying drawings and embodiments.

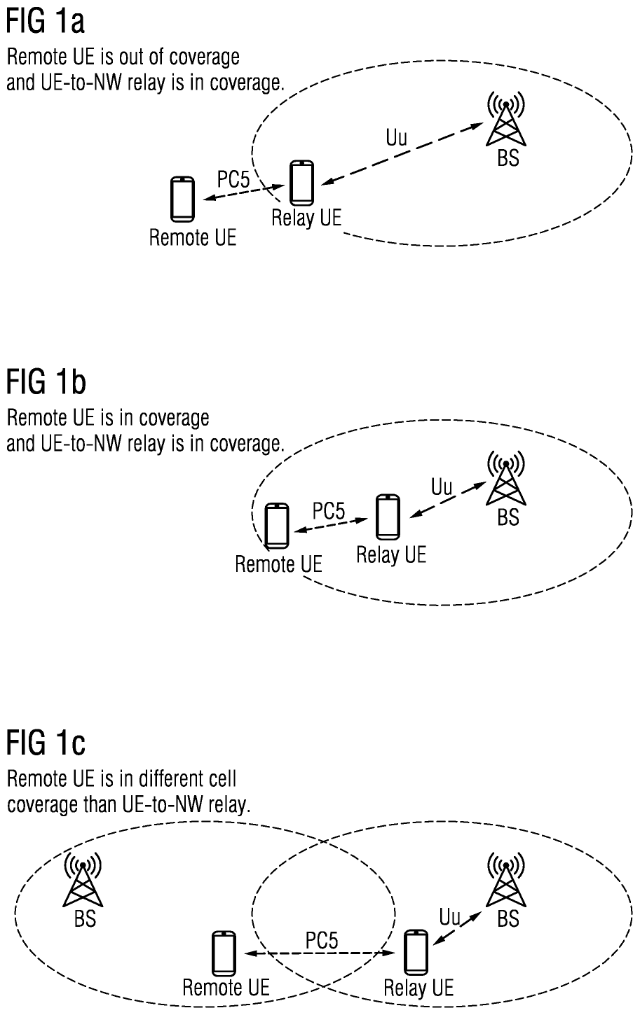

FIG. 1a shows the scenario 1, which displays that remote UE is OOC and UE-to-NW relay is IC.

FIG. 1b shows the scenario 1, which displays that remote UE is IC and UE-to-NW relay is IC.

FIG. 1c shows the scenario 1, which displays that remote UE is in different cell coverage than UE-to-NW relay.

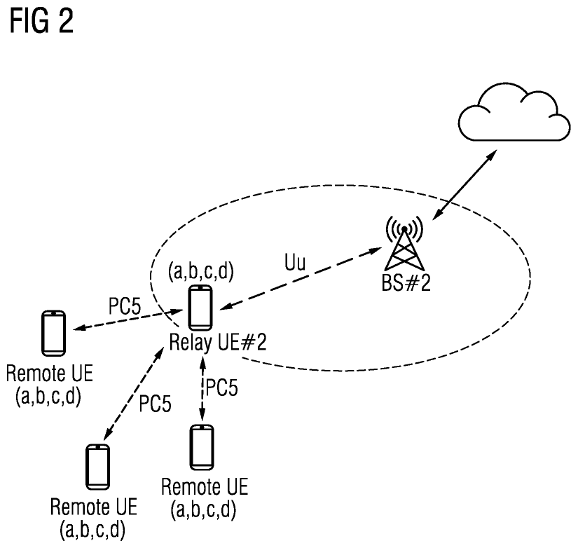

As shown in FIG. 2, the PC5 interface only constitutes the first communication “hop” between Remote UE and Relay UE. However, it is not sufficient to only consider the load related to the PC5 interface connecting remote UE and relay UE, but to take the entire, composite load conditions reflecting the relay UE's PC5 load as well as the relay UE's Uu link condition into account, since both affect the Remote UEs End-to-End (E2E) Quality of Service (QoS).

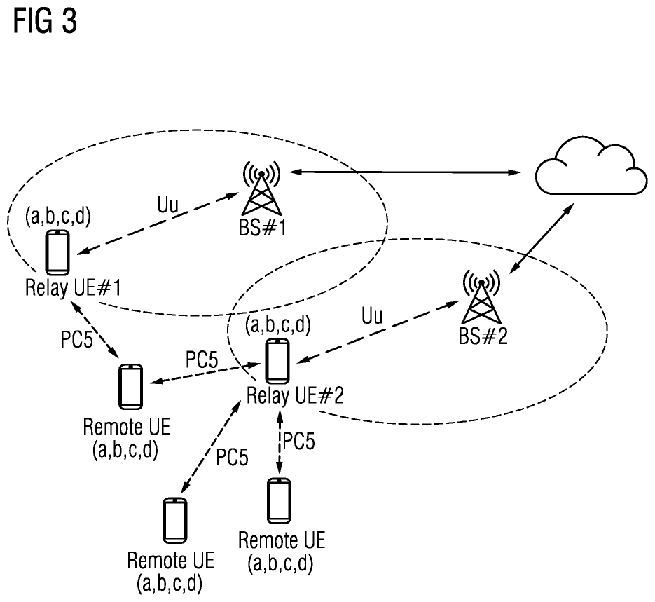

FIG. 3 shows Relay UE #1 and Relay UE #2 are connected to BS #1 and BS #2, respectively. Further, they are both operating as Relay UE towards their respective BS. For example, they can provide Remote UEs with Internet connectivity.

When registering to the mobile network and accessing a particular base station (BS) (e.g., eNB or gNB), connecting UEs can be enabled by the BS to act as a relay UE.

Thus, the corresponding BS is able to manage all relay-capable UEs, in particular, to active or deactivate their operation as a relay. Further, the BS can provide a resource configuration to each relay UE and indicate which resource pool the relay UE can use for providing access to remote UEs. Moreover, the BS manages and grants radio resources to each UE, including relay UEs, for using the Uu interface. For Uu resource assignments and grants, the BS may use proprietary algorithms.

The BS can regularly indicate Uu load conditions, in particular, uplink load conditions (e.g., UL PRB usage per 5QI, total amount of UL PRB usage, UL buffer status) to each relay UE.

Each relay UE will use the uplink load and its own PC5 load information for generating a composite load information. Further, each relay UE will include this composite load information, e.g., in its regular broadcast of discovery and system information, which may be used by Remote UEs for relay (re-)selection.

Further, in case a new Remote UE is searching for a relay UE, which actively announces itself via a “discovery message”, the relay UE can provide the composite load information in response to the Remote UE's announcement (relaying request).

This gives new Remote UEs the chance to (re-)select relay UEs taking the composite load information into account, which can result in smarter decision, and hence, more efficient usage of time and energy resources, i.e., the selection based on an E2E load condition maximizes the changes of obtaining resources to guarantee the required E2E QoS.

For discovering each other, Remote UE and Relay UE use various discovery mechanisms. For example, the Relay UE announces its presence and capabilities by regularly transmitting discovery information in a broadcast manner. Alternatively, Remote UE can announce the presence and inquire for communication partners by issuing corresponding discovery messages regular.

Remote UEs receiving the relay UEs discovery information use this information, e.g., for estimating their distance (using radio-level measurements, such as RSRP) to the respective relay UE. This is a necessary condition, i.e., a minimum RSRP must be fulfilled.

In the embodiment depicted in FIG. 3, the Remote UE might prefer connecting to the Relay UE #2, if only the estimated distance to the nearest Relay UE is considered. However, by taking the composite load information (which is regularly provided by each Relay UE) into account, the blue Remote UE is aware of the overall load conditions it will be facing when connecting to Relay UE #1 or Relay UE #2.

Further, although the distance to Relay UE #1 may appear a bit larger, the Remote UE connects to Relay UE #1 due to its rather relaxed composite load situation provided that Reference Signal Received Power (RSRP) level is sufficient, as indicated in the regular discovery and system broadcast information. Thus, the blue Remote UE will avoid connecting to the highly loaded Relay UE #2 and save time and energy for an unnecessary relay re-selection procedure.

The Uu load information as requested from and provided by the BS includes any type of resources that are used by the Relay UE, including the use of carrier aggregation as well as dual connectivity.

The measurement configuration for Relay UE can be either preconfigured or provided by the network. Here, filtering of measurements and averaging of load indications can be performed with windowed moving average filters and can also be aligned with the gNB's transmission time intervals.

Each relay UE can perform network access/admission control autonomously or on behalf of the BS by checking whether the requested QoS by the Remote UE can be met by the E2E connection taking the composite load information into account. This could reduce latency.

Relay selection can facilitate communication among multiple vehicles/devices, which are located outside mobile network's coverage, in an indirect manner, e.g., multi-hop communication.

The UE measurements are done for RSRP, RSRQ and SNR associated with CRS (Cell Specific Reference Signal). In some systems SS (Synchronization Signal) and CSI (Channel State Information) instead of CRS are useable. For FR-1, the reference point for the measurement shall be the antenna connector of the UE. For FR-2, it shall be measured based on the combined signal from antenna elements corresponding to a given receiver branch.

SS-RSRP stands for Synchronization Signal reference signal received power. It is defined as the linear average over the power contributions (in Watt) of the resource elements that carry SSS. The measurement time resource(s) for SS-RSRP are confined within SS/PBCH Block Measurement Time Configuration (SMTC) window duration.

For SS-RSRP determination, demodulation reference signals for PBCH and, if indicated by higher layers, CSI RS in addition to SSS is used. SS-RSRP using demodulation reference signal for PBCH or CSI reference signal is measured by linear averaging over the power contributions of the resource elements that carry corresponding reference signals taking into account power scaling for the reference signals. This measurement is applicable for following RRC_CONNECTED intra-frequency, RRC_IDLE intra-frequency, RRC_IDLE inter-frequency, RRC_INACTIVE intra-frequency, RRC_INACTIVE inter-frequency, RRC_CONNECTED intra-frequency, RRC_CONNECTED inter-frequency

CSI-RSRP stands for CSI reference signal received power. It is defined as the linear average over the power contributions (in watt) of the resource elements that carry CSI-RS configured for RSRP measurements within the considered measurement frequency bandwidth in the configured CSI-RS occasions. For CSI-RSRP determination CSI reference signals transmitted on antenna port 3000 is used, if CSI_RSRP is used for L1-RSRP, CSI reference signals transmitted on antenna ports 3000, 3001 can be used.

For intra-frequency CSI-RSRP measurements, if the measurement gap is not configured, UE is not expected to measure the CSI-RS resource(s) outside of the active downlink bandwidth part. CSI-RSRP measurement is applicable for following: If CSI-RSRP is used for L1-RSRP, RRC_CONNECTED intra-frequency.

Otherwise, RRC_CONNECTED intra-frequency, RRC_CONNECTED inter-frequency

NR-RSSI stands for NR carrier Received Signal Strength Indicator, it comprises the linear average of the total received power (in Watt) observed only in certain OFDM symbols of measurement time resource(s), in the measurement bandwidth, over N number of resource blocks from all sources, including co-channel serving and non-serving cells, adjacent channel interference, thermal noise etc. The measurement time resource(s) for NR Carrier RSSI are confined within SS/PBCH Block Measurement Time Configuration (SMTC) window duration. For intra-frequency measurements, NR Carrier RSSI is measured with timing reference corresponding to the serving cell in the frequency layer. For inter-frequency measurements, NR Carrier RSSI is measured with timing reference corresponding to any cell in the target frequency layer

CSI-RSSI stands for CSI Received Signal Strength Indicator, it comprises the linear average of the total received power (in Watt) observed only in OFDM symbols of measurement time resource(s), in the measurement bandwidth, over N number of resource blocks from all sources, including cochannel serving and non-serving cells, adjacent channel interference, thermal noise etc. The measurement time resource(s) for CSI-RSSI corresponds to OFDM symbols containing configured CSI-RS occasions.

SS-RSRQ stands for Secondary synchronization Signal Reference Signal Received Quality. It is defined as the ratio of NxSS-RSRP/NR carrier RSSI, where N is the number of resource blocks in the NR carrier RSSI measurement bandwidth. The measurements in the numerator and denominator shall be made over the same set of resource blocks. SS-RSRQ measurement is applicable for following: RRC_IDLE intra-frequency, RRC_IDLE inter-frequency. RRC_INACTIVE intra-frequency, RRC_INACTIVE inter-frequency, RRC_CONNECTED intra-frequency, RRC_CONNECTED inter-frequency.

CSI-RSRQ is defined as the ratio of NxCSI-RSRP to CSI-RSSI, where N is the number of resource blocks in the RSSI measurement bandwidth. The measurements in the numerator and denominator is made over the same set of resource blocks. CSI-RSRQ measurement is applicable for following: RRC_CONNECTED intra-frequency, RRC_CONNECTED inter-frequency.

SS-SINR stands for SS signal-to-noise and interference ratio. It is defined as the linear average over the power contribution (in Watt) of the resource elements carrying SSS divided by the linear average of the noise and interference power contribution (in Watt) over the resource elements carrying SSS within the same frequency bandwidth. SS-SINR measurement is applicable for following: RRC_CONNECTED intra-frequency, RRC_CONNECTED inter-frequency

CSI-SINR stands for CSI signal-to-noise and interference ratio. It is defined as the linear average over the power contribution (in Watt) of the resource elements carrying CSI reference signals divided by the linear average of the noise and interference power contribution (in Watt) over the resource elements carrying CSI reference signals within the same frequency bandwidth. SS-SINR measurement is applicable for following: RRC_CONNECTED intra-frequency, RRC_CONNECTED inter-frequency

Within another embodiment proximity services as well as group communications in remote or disaster areas using relay nodes as intermediaries are realized. Proximity Services (ProSe) are short-range services realized by means of D2D communication between mobile devices. For this purpose, the mobile devices must support the direct connection, which is comparable to the function of walkie-talkies. The radio interface implemented for this purpose is called Sidelink.

The mobile devices with ProSe function have a search function for finding connection requests. For this purpose, a mobile device sends a special request code to the network operator, which checks the traffic load and other network functions, and sends a ProSe Application Code (PAC) to the requesting device, whereupon the latter sends the PAC code at regular intervals.

Further group communications may also include any form of communications required to coordinate swarms of robots or automated machinery.

And the network topology reconstruction function in the present invention can simplify network planning and network management, so that network deployment cost and maintenance and management expenses could be saved.

The present invention can fulfill the update of the connection relationship of a wireless relay station and can take steps to further guarantee the service suspension time of the terminals and RSs subjected to the wireless relay station is the shortest.

Adopting the technical scheme, the base station regulates radio resource reserved to the relay based on load condition of the relay and measurement information of the relay, so that QoS of the terminal controlled by the relay is effectively guaranteed, meanwhile resource is fully coordinated, and frequency spectrum utilization is improved.

The inventive approach is based on filtering, averaging, based on statistics with respect to configurable time window, in order determine a composite load metric. The load metric captures better the conditions on average.

Load metric or the load can be determined/estimated using the following parameters, like Radio aspects, Quality of Service (QoS) aspects, HW aspects or User activity alone or in every combination.

Radio aspects can be covered by radio resource usage per Relay UE and gNB, respectively. Based on network configuration, the amount of available radio resources e.g., physical resource blocks, bandwidth parts can be determined. This covers MIMO operation, too. In case of usage of network features, such as carrier aggregation or dual-connectivity, the amount of radio resources increases with the additional carrier spectrum. The gNB should regularly assess the inference conditions, e.g., neighbor channel interference or wideband interference. Interference becomes visible in increased packet loss. The relay UE only perform such measurements, if instructed/configured by gNB. These measurements are performed and are available permanently.

Quality of Service (QoS) aspects can be considered for the load. Each service provided via a Radio Access Bearer (RAB)) is linked to a QoS profile (Uu: “5QI” and PC5: “PQI”). Based on these profile data handling priorities are determined. Thus, there are multiple data buffers/queues depending on HW implementation. QoS is about guaranteed rates for example and hence priorities if channel is loaded of low priority traffic. QoS is about guaranteed rates for example and hence priorities if channel is loaded of low priority traffic

HW aspects can be considered for the load, too. Buffer status per Relay UE and gNB, respectively, depends on the node-specific buffer space/capacity for data packets that takes QoS profiles into account. For example, there may be different queues depending on data traffic priorities. One could calculate the time average time a certain amount of data (e.g., MAC PDU, RLC PDU, PDCP PDU) spends in the respective buffer/queue. Here, low-latency data traffic would be given higher priority and, thus, weight when calculating load based on buffer status. Implementation-specific can be said, that, Relay UE may be consider its own CPU load, memory and power consumption, as well as battery status. The Relay UE behavior can be tuned, e.g., selfish vs. social and then determines interest-related aspect. Further, Relay UE's relative speed and location can be useful for optimization. In summary, the Relay UE load determination does not need to follow established rules and this approach creates more flexibility.

User activity is also considered for the load. Besides the total number of managed connections, it should be differentiated with respect to active connections vs. idle connections already handled by Relay UE and gNB, respectively. Number of new access requests in the configured averaging time window per Relay UE and gNB, respectively for establishing a connection. Number new bearer requests in the configured averaging time window per Relay UE and gNB, respectively can be used, where each request is linked to a certain QoS-type. Based on this estimation needed radio resources and service priority. Furthermore, the number of granted access attempts in the configured averaging time window per Relay UE and gNB can be used, respectively. Number of blocked access attempts can be used to and this usually happens when load is already high.

In this option, a relay UE candidate can indicate how much bit rate or bandwidth a remote UE can achieve for its relay traffic if the remote UE connects to the relay UE candidate. This bit rate or bandwidth may be determined as the maximum bit rate/bandwidth of the relay UE candidate in Uu interface minus bit rate/bandwidth for relay traffic occupied by remote UEs which are being served by the relay UE in PC5 interfaces. This free bandwidth or achievable bit rate may be determined for UL relay traffic (i.e., from remote UE to gNB) and DL relay traffic (i.e., from gNB to remote UE) separately. In this option, relay UE candidate can estimate its maximum Uu bit rate/bandwidth based on implementation. It is feasible that relay UE candidate can perform estimation based on its radio channel quality or the historic UL grants or DL assignments. gNB may also provide assistance information e.g. measure UL channel quality and provide estimated UL bit rate to relay UE) accordingly.”

In a preferred embodiment the method for Relay Selection based on Multi-Interface Load Metric between communication subscribers (Remote UE 10, 20, 30), which can each communicate with at least one base station (BS #1, BS #2) via at least one communication interface (a, b, c, d) for communication, in which the following steps are carried out on the part of the base station (BS) for establishing communication, determining local and thematic information for determining communication subscribers (Remote UE 10, 20, 30), determining a group of communication subscribers (Remote UE 10, 20, 30) based on the local and thematic information, wherein a local area is defined for local restriction of the communication subscribers (Remote UE 10, 20, 30) and wherein at least one of a technological aspect and an interest-related aspect is used for thematic restriction on the part of the base station (BS #1, BS #2) is characterized by granting permission to communicate data from a group of communication subscribers (Remote UE 10, 20, 30) to the at least one base station (BS #1, BS #2) is established via further communication subscribers (Relay UE #1, Relay UE #2) by using discovery mechanisms between them.

In a preferred embodiment the method is characterized by the steps that at least one base station (BS #1, BS #2) computes and provides to further communication subscribers (Relay UE #1, Relay UE #2) the node in the resources assigned for relaying, broadcast this to further communication subscribers (Relay UE #1, Relay UE #2), relaying request indicating QoS parameters, acceptance by further communication subscribers (Relay UE #1, Relay UE #2) or at least one base station (BS #1, BS #2)

In a preferred embodiment the method is characterized in that, that a possible relay node request of further communication subscribers (Relay UE #1, Relay UE #2) is done by on-demand)

In another a preferred embodiment the method is characterized in that, a discovery mechanism used by further communication subscribers (Relay UE #1, Relay UE #2) is established by announcing its presence and capabilities by regularly transmitting discovery information in a broadcast manner.

Another embodiment of the method is characterized by a discovery mechanism used by communication subscribers (Remote UE 10, 20, 30) is established by announcing their presence and inquire for communication partners by issuing corresponding discovery messages regularly.

A further preferred embodiment of the Method is characterized in that, that once the group has been determined by at least one further communication subscriber (Relay UE #1, Relay UE #2) based on network configuration and prioritization by the base station (BS #1, BS #2)) of the data transmitted (Uu) for the group of communication subscribers (Remote UE 10, 20, 30) to the base station (BS #1, BS #2).

A further preferred embodiment of the method is characterized in that, that data transmitted (Uu) for the group of communication subscribers (Remote UE 10, 20, 30) as requested from and provided by the base station (BS #1, BS #2) a technological aspect includes at least any type of resources that are used by the communication subscribers (Remote UE 10, 20, 30).

A further preferred embodiment of the method is characterized in that, that technological aspect includes at least any type of resources including the use of Bandwidth Parts, whereby Bandwidth Parts consists of contiguous sub-set of resources within a Component Carrier.

A further preferred embodiment of the method is characterized in that, that technological aspect includes at least any type of resources including the use of carrier aggregation.

A further preferred embodiment of the method is characterized in that, that technological aspect includes at least any type of resources including dual connectivity.

A further preferred embodiment of the method is characterized in that, that technological aspect includes the aspect of relay selection single-hop or multi-hop PC5-to-Uu relaying by introducing a composite load metric.

A further preferred embodiment of the method is characterized in that, that the relay selection meets the communication subscribers (Remote UE 10, 20, 30) E2E QoS requirements, and triggering a procedure for selection and/or reselection for further communication subscribers (Relay UE #1, Relay UE #2).

A further preferred embodiment of the method is characterized in that, that the communication subscribers (Remote UE 10, 20, 30) are users (10, 20, 30).

A further preferred embodiment of the method is characterized in that, that the local and thematic information is determined from the mean value of the spatial coordinates of the end users (10, 20, 30) and the respective relative speed v and average direction of the end users (10, 20, 30).

A embodiment of a vehicle unit is characterized by comprising a communication unit for communication in a vehicle of a user (10, 20, 30, 40) to a at least one base station (BS #1, BS #2) comprising a microprocessor, volatile and non-volatile memory and at least one communication interface (a, b, c, d), which are communicatively connected to the at least one base station (BS #1, BS #2) or further communication subscribers (Relay UE #1, Relay UE #2) via one or more mobile communication lines, wherein the system (100) is adapted to execute the method according to one or more of claims 1-14.

A further preferred embodiment is characterized by a computer program product comprising instructions that, when the program is executed by a computer, cause the computer to execute the method according to one or more of claims 1-14.

A further preferred embodiment is characterized by computer-readable medium on which the computer program product according to claims 1 to 11 is stored.

A further preferred embodiment is characterized by Vehicle having one or more vehicle units according to claim 14.

1. A method for Relay Selection based on Multi-Interface Load Metric between communication subscribers which can each communicate with at least one base station via at least one communication interface for communication, in which the following steps are carried out on the part of the base station for establishing communication:
Determining local and thematic information for determining communication subscribers;
Determining a group of communication subscribers based on the local and thematic information, wherein a local area is defined for local restriction of the communication subscribers and wherein at least one of a technological aspect and an interest-related aspect is used for thematic restriction on the part of the base station;
characterized in that,
granting permission to communicate data from a group of communication subscribers to the at least one base station is established via further communication subscribers by using discovery mechanisms between them.

2. The method according to claim 1, wherein
a) at least one base station computes and provides to further communication subscribers the node in the resources assigned for relaying
b) broadcast this to further communication subscribers
c) relaying request indicating QoS parameters
d) acceptance by further communication subscribers or at least one base station.

3. The method according to claim 1,
characterized in that,
a possible relay node request of further communication subscribers is done on-demand.

4. The method according to claim 1,
characterized in that,
a discovery mechanism used by further communication subscribers is established by announcing its presence and capabilities by regularly transmitting discovery information in a broadcast manner.

5. The method according to claim 1,
characterized in that,
a discovery mechanism used by communication subscribers is established by announcing their presence and inquiring for communication partners by issuing corresponding discovery messages regularly.

6. The method according to claim 1,
characterized in that,
once the group has been determined by at least one further communication subscriber based on network configuration and prioritization by the base station of the data transmitted for the group of communication subscribers to the base station.

7. The method according to claim 1,
characterized in that,
data transmitted for the group of communication subscribers as requested from and provided by the base station a technological aspect includes at least any type of resources that are used by the communication subscribers.

8. The method according to claim 1,
characterized in that,
technological aspect includes at least any type of resources including the use of Bandwidth Parts, whereby Bandwidth Parts consists of contiguous sub-set of resources within a Component Carrier.

9. The method according to claim 1,
characterized in that,
technological aspect includes at least any type of resources including the use of carrier aggregation.

10. The method according to claim 1,
characterized in that,
technological aspect includes at least any type of resources including dual connectivity.

11. The method according to claim 1,
characterized in that,
technological aspect includes the aspect of relay selection single-hop or multi-hop PC5-to-Uu relaying by introducing a composite load metric.

12. The method according to claim 1,
characterized in that,
the relay selection meets the communication subscribers E2E QoS requirements, and triggering a procedure for selection and/or reselection for further communication subscribers.

13. The method according to claim 1,
characterized in that,
the communication subscribers are users.

14. The method according to claim 1,
characterized in that,
the local and thematic information is determined from the mean value of the spatial coordinates of the end users and the respective relative speed v and average direction of the end users.

15. A vehicle unit comprising a communication unit for communication in a vehicle of a user to a at least one base station comprising a microprocessor, volatile and non-volatile memory and at least one communication interface, which are communicatively connected to the at least one base station or further communication subscribers via one or more mobile communication lines, wherein the system (100) is adapted to perform operations, for Relay Selection based on Multi-Interface Load Metric between communication subscribers, on the part of the at least one base station for establishing communication, the operations comprising:
Determining local and thematic information for determining communication subscribers;
Determining a group of communication subscribers based on the local and thematic information, wherein a local area is defined for local restriction of the communication subscribers and wherein at least one of a technological aspect and an interest-related aspect is used for thematic restriction on the part of the base station;
characterized in that,
granting permission to communicate data from a group of communication subscribers to the at least one base station is established via further communication subscribers by using discovery mechanisms between them.

16. (canceled)

17. (canceled)

18. (canceled)

19. The vehicle unit according to claim 15, wherein
a) at least one base station computes and provides to further communication subscribers the node in the resources assigned for relaying
b) broadcast this to further communication subscribers
c) relaying request indicating QoS parameters
d) acceptance by further communication subscribers or at least one base station.

20. The vehicle unit according to claim 15,
characterized in that,
a possible relay node request of further communication subscribers is done on-demand.

21. The vehicle unit according to claim 15,
characterized in that,
a discovery mechanism used by further communication subscribers is established by announcing its presence and capabilities by regularly transmitting discovery information in a broadcast manner.

22. The vehicle unit according to claim 15,
characterized in that,
a discovery mechanism used by communication subscribers is established by announcing their presence and inquiring for communication partners by issuing corresponding discovery messages regularly.

23. The vehicle unit according to claim 15,
characterized in that,
once the group has been determined by at least one further communication subscriber based on network configuration and prioritization by the base station of the data transmitted for the group of communication subscribers to the base station.
